(19) United States
(12) Patent Application Publication
(10) Pub. No.: US 2016/0133153 A1
(43) Pub. Date: May 12, 2016

(54) Training Management System and Smartphone Application

(71) Applicant: William Brandon Mahoney, Belton, MO (US)

(72) Inventor: William Brandon Mahoney, Belton, MO (US)

(21) Appl. No.: 14/938,866

(22) Filed: Nov. 12, 2015

Related U.S. Application Data
(60) Provisional application No. 62/078,467, filed on Nov. 12, 2014.

(51) Int. Cl. G09B 19/00; G09B 5/02

(52) U.S. Cl. CPC G09B 19/0038; G09B 5/02

(57) ABSTRACT

A system or method that consists of a training journal which logs all training conducted in relation to Martial Arts or Combat Sports and then outputs logged training into readable statistics to aid a user in the tracking and monitoring of training for Martial Arts and Combat Sports.

### PARENT CASE TEXT

This application is a continuation of Provisional Patent Application No. 62/078,467, which was originally filed Nov. 12, 2014, which is incorporated herein by reference in its entirety.

### BACKGROUND

The present invention relates to training management applications and software for hand held devices or computers, and in particular to smartphone applications and desktop management programs for tracking and sharing training in combat sports and martial arts. Participants in combat sports or martial arts training often desire to record and track their own or their students' daily training in order to monitor their training progress. Currently, students and teachers of martial arts and combat sports usually use a notebook or other manual method to keep track of training efforts. Not only is this cumbersome and time consuming, it does not show the participant any statistics related to their training without significant time and calculation efforts. As such, there is a distinct need for a application (or “app”) that can be run on handheld devices and computers, such as iPhones, Android, iPad, tablets, etc. that can be used to log and track training records in regards to combat sports and martial arts.

### BRIEF SUMMARY OF THE INVENTION

For the purposes of the present invention, “combat sports” denotes any competitive contact sport of one-on-one combat in which a winner is selected based on the rules of the individual sport. Examples of “combat sports” include, but are not limited to, kickboxing. Jiu-Jitsu, wrestling, boxing, Muay Thai, Judo, etc. For the purposes of the present invention, “martial arts” denotes any of the many forms of fighting or self-defense systems that are codified and which may or may not be practice as a sport.

The present invention seeks to meet the need to track and monitor progress of those training in combat sports and martial arts by providing an app for a handheld device and computer to allow users to log in and record their training workouts. The logged training workouts are then converted into readable statistical charts and tables that users can track and monitor their training progress. Smartphones are akin to handheld computers integrated with mobile telephones that may run complete operating system software providing a platform for advanced application such as the smartphone application used in the present invention. However, the present invention is not limited to smartphone applications, as the program may also run on desktop computers or other handheld devices. As such, use of “smartphone application” may be used interchangeably with desktop computer program in the context of the present invention.

In the most basic form, the present invention comprises of a smartphone application with a user interface wherein the user may log and track training associated with martial arts or combat sports. The application or software is able to generate specific training statistics for each user that allows the user to monitor training progress or change training parameters as needed. The details of these statistic creating abilities are further described below and shown in the accompanying illustrations of the smartphone application user interface.

In one embodiment of the present invention, training is displayed on a line chart showing average hours spent in various aspects of training from month to month over a given period of time, otherwise known as a “training timeline.” This can be displayed by one of two methods. In the first method training is totaled for each month and then divided by the number of days in said month and then multiplied by 7 to achieve average time spent training per week for any given month. In the second method training is shown as the total amount of time spent training every month and not by the average per week.

### EXAMPLE 1

August 2013 Total hours spent training: 45
(45/31 days in month)×7 days in a week=10.16 average hours per week
The chart would display 10.16 hours of training

### EXAMPLE 2

August 2013 total hours spent training: 45
The chart would display 45 hours of training on the chart for the month of August.

In a second embodiment of the present invention, a training focus pie chart is created by the application that shows the percentage of total time spent on varying aspects of training in relation to other aspects over a given period of time. The training for all given training categories are totaled and then divided by the grand total of time spent training over a given time period to create individual percentages.

### EXAMPLE 3

Total time spent training over a given year: 500 hours

| | |
|---|---|
| Total time spent training in grappling: 150 hours | 150/500 = 30% |
| Total time spent training in striking: 225 hours | 225/500 = 45% |
| Total time spent on conditioning: 125 hours | 100/500 = 20% |
| Total time spent training in self defense or combatives | 25/500 = 5% |

In a further embodiment, the training categories can be broken down as any number of sub categories into a new pie chart.

### EXAMPLE 4

Striking: 225 hours

| | |
|---|---|
| Shadowboxing: 56.25 hours | 56.25/225 = 25% |
| Mitts/Pads: 22.5 hours | 22.5/225 = 10% |
| Partner Drills: 22.5 hours | 22.5/225 = 10% |
| Heavy bags: 56.25 hours | 56.25/225 = 25% |
| Light bags: 22.5 hours | 22.5/225 = 10% |
| Sparring: 45 hours | 45/225 = 2.0% |

In another embodiment of the present invention, the application creates a user specific training totals table wherein the training totals completed in a given category are added in terms of total time or rounds for a given period of time. Training totals may include, but are not limited to, rounds completed of sparring, Thai pads, jump rope, and total time spent on weightlifting, jump rope, wrestling, etc. For the purpose of the present invention the well-known term used in Martial Arts and Combat Sports known as a ‘round’ or ‘rounds’ denotes a given interval of training. For example if a given training exercise was performed for a set number of minutes a total of 3 times then as an example an individual could consider that they performed 3 rounds of training.

In another embodiment of the present invention, the application creates a user specific table wherein the total successful submissions of a user over a given period of time are displayed. For the purpose of the present invention the term ‘submission’ denotes when a practitioner of Martial Arts or Combat Sports forces another practitioner to concede due to a joint lock or choke hold either verbally or physically. Submissions are broken down into different categories displaying to a user the amount of each category in relation to the others and the total number of successful submissions is displayed.

### EXAMPLE 5

| | | |
|---|---|---|
| Gi Chokes | 30 | 30% |
| Naked Chokes | 20 | 20% |
| Triangle Chokes | 10 | 10% |
| Arm Locks | 10 | 10% |
| Leg/Foot Locks | 10 | 10% |
| Shoulder Locks | 20 | 20% |
| Slicers/Wrist Locks | 0 | 0% |
| Spinal Locks | 0 | 0% |
| Total Taps | 100 | |

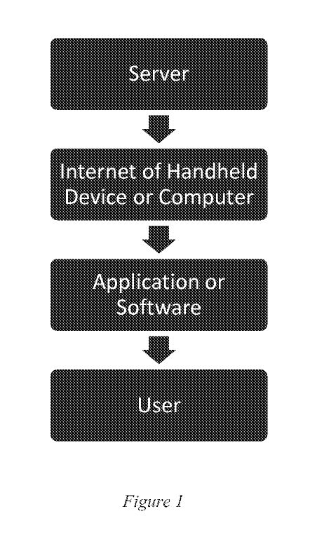

Further embodiments and features of the present invention are further shown and described below in FIGS. 1-12.

FIG. 1. Details flow chart of information of the present invention when displaying stats. The user accesses the application or software which communicates through the internet with a server where it stores information regarding completed training of user. That information is then used to create an individual users training statistics which are then gather from the server when user wishes to view their stats.

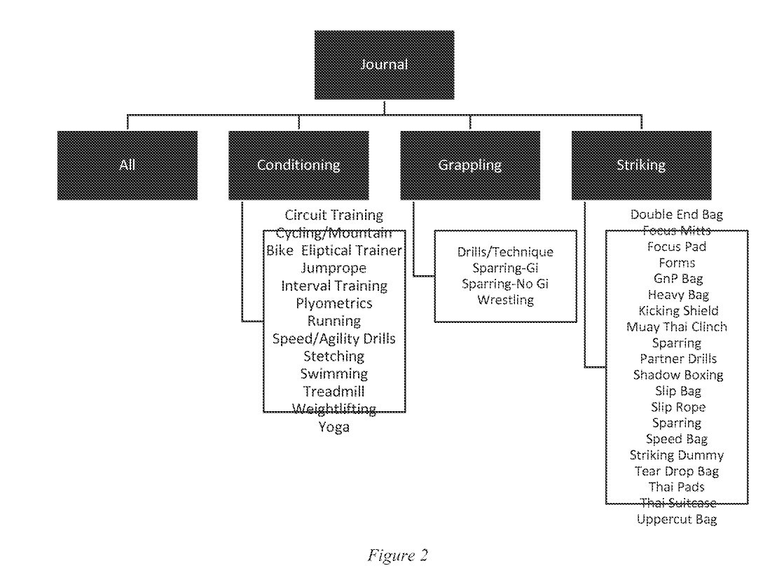

FIG. 2. Details a breakdown of the categories preprogrammed in the current inventions journal which a user can use to record their training.

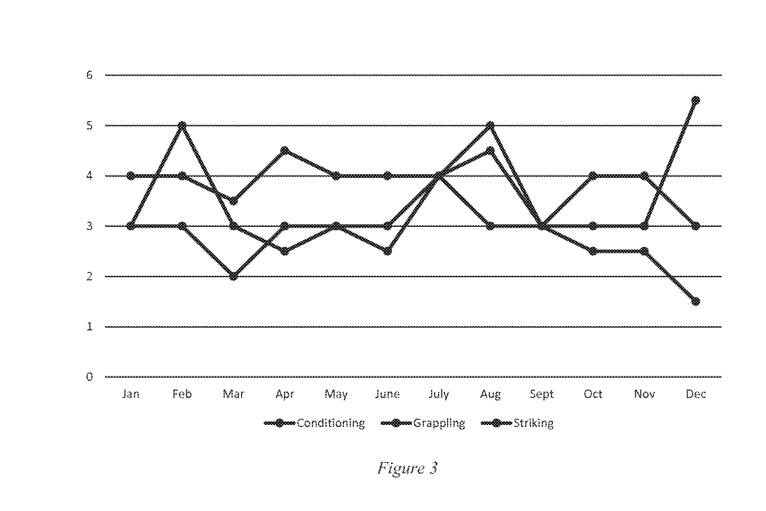

FIG. 3. Details an example of a timeline showing the average hours trained per week in a given month.

FIG. 4. Details a pie chart showing the percentages of training conducted by category.

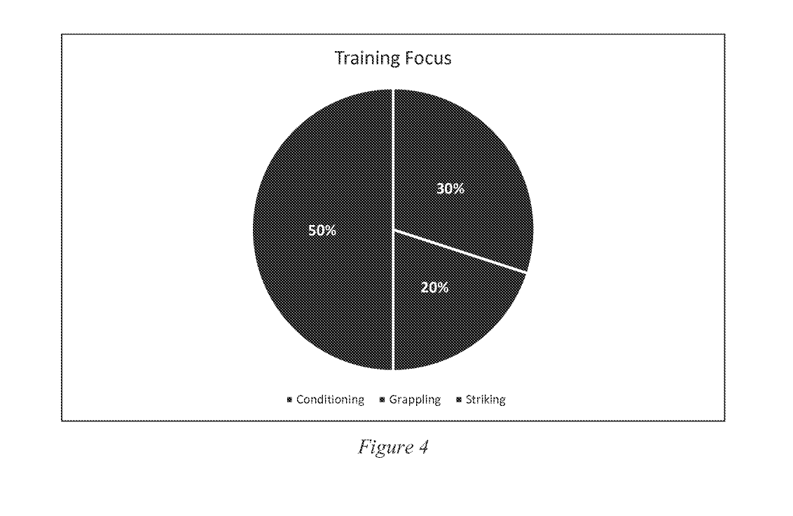

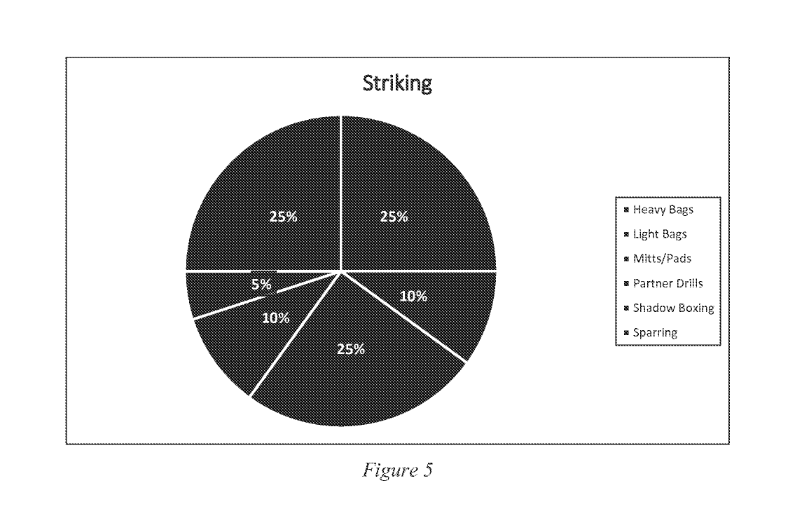

FIG. 5. Details a further breakdown of striking category.

FIG. 6. Details a further breakdown of the grappling category.

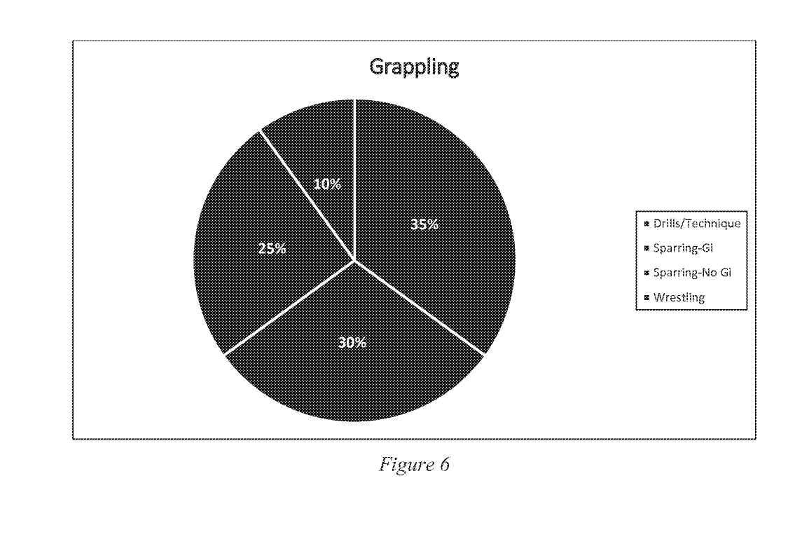

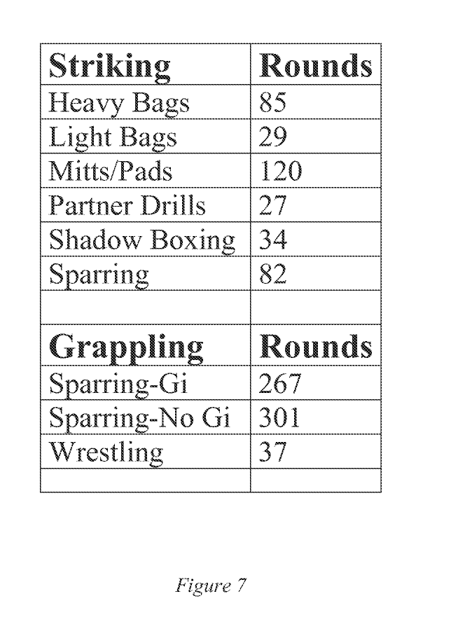

FIG. 7. Details a chart displaying totals of training recorded in a journal.

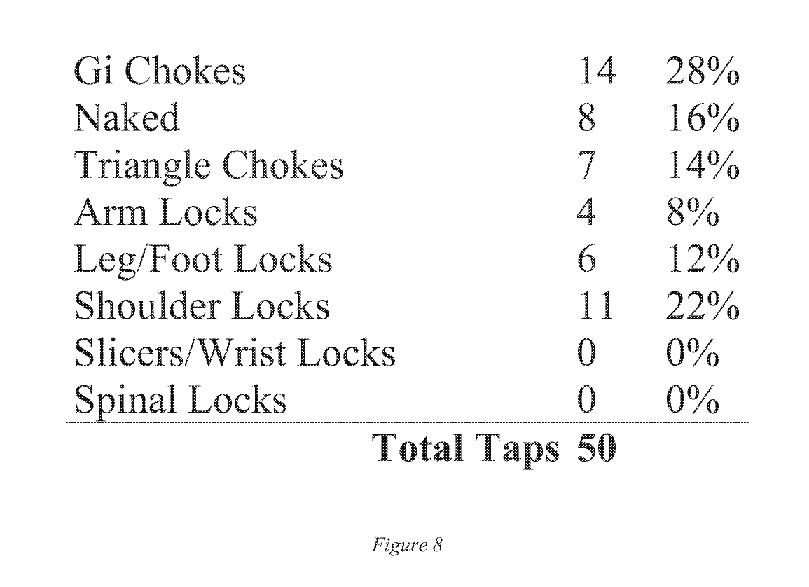

FIG. 8. Details a table showing successful submissions completed.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A system or method, comprising of an application or software and server to be used in conjunction with a handheld device or computer, to record training in various forms of Martial Arts and Combat Sports of an individual user of the application or software and using said recorded training, create readable statistics to aid a user in the monitoring of said training over a given period of time.

2. A system or method of claim 1 in which training is logged into a journal contained within the application or software by way of preprogrammed categories and subjects.

3. A system or method of claim 1 in which a timeline in the form of a chart or graph is created from information recorded with the application or software by a user so as to allow the user to track their training volume over a given period of time.

4. A system or method of claim 1 in which allocation of time spent, training recorded in the application or software is displayed in a chart showing the percentage of the total time spent training allocated to individual categories over a given period of time.

5. A system or method of claim 4 in which individual categories are then further broken down into sub categories and the total time spent conducting training of each sub category are displayed as a chart displaying percentages of the total time spent training in reference to the main category as recorded in the journal of the application or software over a given period of time.

6. A system or method of claim 1 in which a table is created out of training recorded in the form of rounds in the application or software is displayed in the form of total rounds completed over a given period of time.

7. A system or method of claim 1 in which a table is created out of training recorded in the form of duration of time in the application or software is displayed in the form of total hours and or minutes and or seconds completed over a given period of time.

8. A system or method of claim 1 in which a chart or table is created out of successful submission attempts during sparring recorded with the application or software.

9. A system or method of claim 8 in which a pie chart displays percentages of each category of types of submissions in relation to each other over a given period of time.

10. A system or method of claim 8 in which a table totals all successful submission attempts recorded in the application or software showing a user their total number of successful submission attempts over a given period of time.
